(19) United States
(12) Patent Application Publication
(10) Pub. No.: US 2017/0091878 A1
(43) Pub. Date: Mar. 30, 2017

(54) METHOD AND SYSTEM FOR CONTROLLING CHARGE AND DISCHARGE OF HIGH POWERED ENERGY STORAGE SYSTEMS

(71) Applicant: Texas Tech University System, Lubbock, TX (US)

(72) Inventor: Anitha Sarah Subburaj, Lubbock, TX (US)

(21) Appl. No.: 15/263,760

(22) Filed: Sep. 13, 2016

Related U.S. Application Data
(60) Provisional application No. 62/232,637, filed on Sep. 25, 2015.

(51) Int. Cl. G06Q 50/06; H01M 10/42; H02M 5/42; G05B 13/04; H02J 3/38; H01M 10/46; G06Q 40/04

(52) U.S. Cl. CPC G06Q 50/06; H01M 10/46; H01M 10/425; G06Q 40/04; G05B 13/042; H02J 3/386; H02M 5/42; H01M 2220/10; G05B 2219/49068

(57) ABSTRACT

A modeling framework performs an economic analysis of a battery storage system to determine the economic feasibility with different business opportunities. The installed battery system can be utilized to optimize the energy flow between the wind farm and the utility. Several factors can be considered when performing the analysis, the most important being, how to determine the best optimal time to charge and discharge the battery to maximize economic benefit.

### CROSS-REFERENCE TO PROVISIONAL APPLICATION

This nonprovisional patent application claims the benefit under 35 U.S.C. §19(e) of U.S. Provisional Patent Application Ser. No. 62/232,637 filed on Sep. 25, 2015, entitled “Method and System for Controlling Charge and Discharge of High Powered Energy Storage Systems”. U.S. Provisional Patent Application Ser. No. 62/232,637 is incorporated herein by reference in its entirety.

### TECHNICAL FIELD

Embodiments are related to high powered energy storage systems. Embodiments also relate to methods and systems for controlling charge and discharge of high energy storage systems. Embodiments also relate to the economic analysis of high powered energy storage systems.

### BACKGROUND

In the past several years, there has been tremendous increase in power production by renewable energy resources and the energy projection profiles indicate that the trend will continue for the next decade. Yet there has been little economic analysis of battery storage systems utilized for renewable energy sources. The conclusion is that the main renewables like wind and the sun, face a major problem because of their intermittency (e.g., the wind doesn't always blow nor the sun always shine) and that this has not been adequately factored into discussions of their potential.

Without new storage technologies that can overcome this intermittency, much of the decarbonization of the economy will have to come from nuclear energy sources and also simply energy efficiency (e.g., geothermal and biofuels can make small contributions). New energy storage technologies could greatly increase the role of renewables, but none are, currently in sight. The development and application of the battery energy storage system in various fields such as electric vehicle, renewable energy and grid has been increasing due to its ability to store energy. The benefits, however, are often difficult to quantify due to the complexity of different energy and storage applications. Moreover, an economic analysis is essential for the feasibility of the battery storage system.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

The disclosed embodiments provide for a modeling framework that performs an economic analysis on a battery storage system to determine the economic feasibility with different business opportunities. The installed battery system can be utilized to optimize the energy flow between the wind farm and the utility. There are several factors that need to be considered when performing the analysis, the most important being, how to determine the best optimal time to charge and discharge the battery to maximize economic benefit.

The disclosed embodiments involves a method, system and framework that outlines a set of building blocks, which carries out an economic analysis of a battery storage system. Furthermore, special focus is given on describing how to use algorithm for battery cycle life estimation, since the cycle life plays a central role in the economic analysis of battery storage system. This can be accomplished considering two factors; cost of energy required to purchase the power to charge the battery, the cost of energy required to sell the excess power, and the availability of renewable power in an economic way considering the past, present and future cost analysis.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram depicting an electric power infrastructure system, in accordance with an example embodiment;

FIG. 2 illustrates a block diagram of a system for economic analysis, in accordance with an example embodiment;

FIG. 3 illustrates a flow chart of operations depicting a method of economic analysis, in accordance with an example embodiment;

FIGS. 4A-4B illustrate a flow chart of operations depicting a method for determining conditions when wind power is greater than the load and when it is less than the load, in accordance with an example embodiment;

FIGS. 5A-5B illustrate a flow chart of operations depicting a method for considering possible cases when the power supply from the renewable source is less and unable to meet the load, in accordance with an example embodiment;

FIG. 6 illustrates a screen shot of graphically displayed fields with output data regarding the selling of excess power and a recommended course of action to charge a battery in the future, in accordance with an example embodiment;

FIG. 7 illustrates a screen shot of graphically displayed fields with output data indicating a recommended course of action to charge a battery, in accordance with an example embodiment;

FIG. 8 illustrates a screen shot of graphically displayed fields with output data indicating a recommended course of selling excess energy and discharging the battery in the present, in accordance with an example embodiment:

FIG. 9 illustrates a schematic view of a computer system, in accordance with an embodiment and

FIG. 18 illustrates a schematic view of a software system including a module, an operating system, and a user interface, in accordance with an embodiment.

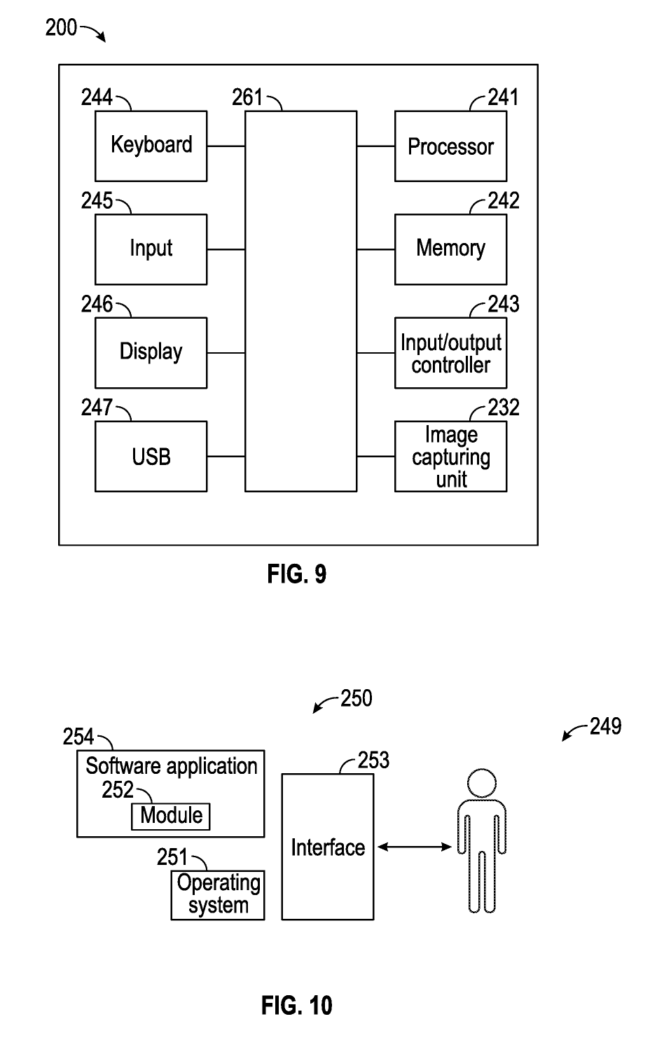

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to identical, like or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In an example embodiment, a modeling framework can be implemented, which performs an economic analysis on a battery storage system to determine the economic feasibility with different business opportunities. The installed battery system is utilized to optimize the energy flow between the wind farm and the utility. There are several factors that need to be considered when performing the analysis, the most important being how to determine the best optimal time to charge and discharge the battery to maximize economic benefit.

In some embodiments, methods and/or systems can be implemented which include an algorithm or a framework that outlines a set of building blocks, and which carries out an economic analysis of a battery storage system. Furthermore, special focus is given on describing how to use algorithm for battery cycle life estimation, since the cycle life plays a central role in the economic analysis of battery storage system. This is accomplished considering two factors: cost of energy required to purchase the power to charge the battery, the cost of energy required to sell the excess power, and the availability of renewable power in an economic way considering the past, present, and future cost analysis.

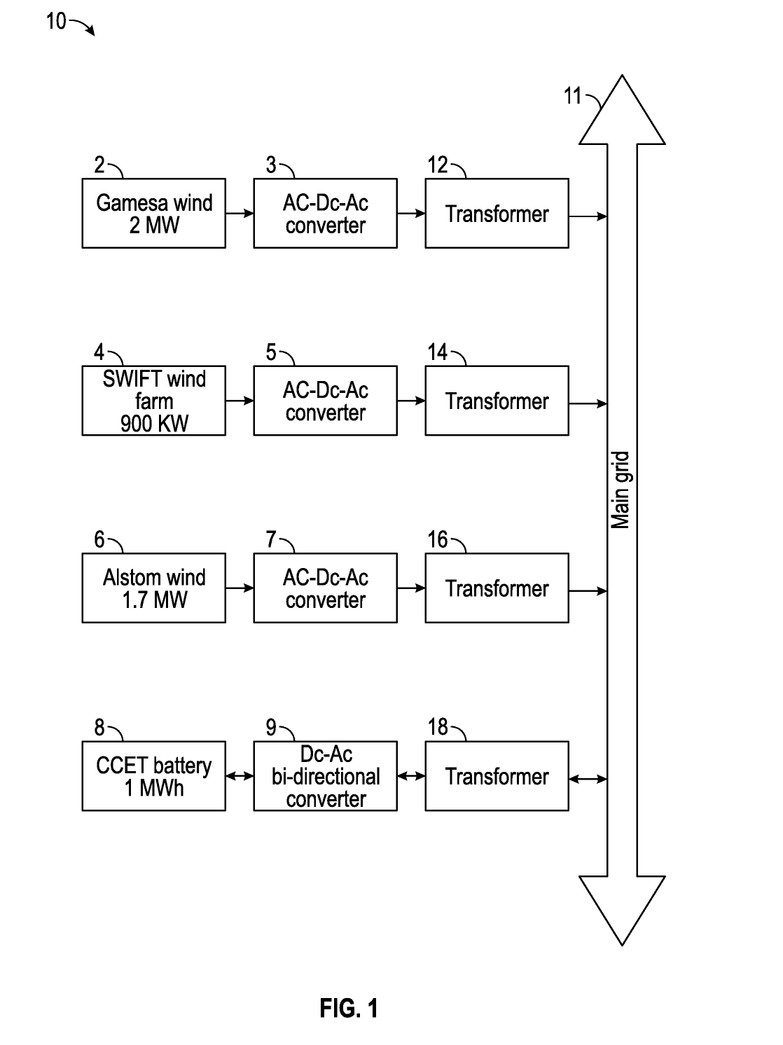

FIG. 1 illustrates a block diagram depicting an electric power infrastructure system 10, in accordance with an example embodiment. Economic analysis is essential to decide the feasibility of the storage or electric power infrastructure system 10. Various factors need to be considered when performing such an analysis. One of the most important factors is a determination of the best/optimal time for charging and discharging the battery or batteries utilized in the context of the electric power infrastructure system 10. Such a battery needs to be charged at times of low cost when demand is low and discharged at times of high cost when demand is high.

In the system 10 shown in FIG. 1 various battery and wind production components or modules are shown. For example, wind production (e.g., “Gamesa Wind”) shown at block 2 along with a wind production from, a SWIFT wind farm as depicted at block 4. Additional wind production is shown at block 6 (e.g., Alston Wind) and battery production (e.g., CCET battery) as depicted at block 8. Output from these components or facilities are respectively provided to Ac-Dc-Ac converts 3, 5, and 7, and a Dc-Ac bi-directional converter 9. Output from converters 3, 5, 7, and 9 are respectively provided to transformers 12, 14, 16, 18 with output to a main electrical grid 11.

The installed battery is utilized to optimize the energy flow between the wind farm and the utility. Due to the intermittency of wind production, the battery can act as a backup storage unit to supply power to the main grid at peak demand. The battery can be connected at, for example, the main grid 11 (e.g., 12.5 kV main grid). The battery can be charged or discharged by the bi-directional converter as shown in FIG. 1 to manage power flow to and from the grid. The economic analysis depends on the cost of energy required to purchase the power to charge the battery and the cost of energy required to sell the excess power. The next important factor is to consider the load/demand and supply of the battery power or the available renewable power in an economic way considering the past, present, and future cost analysis.

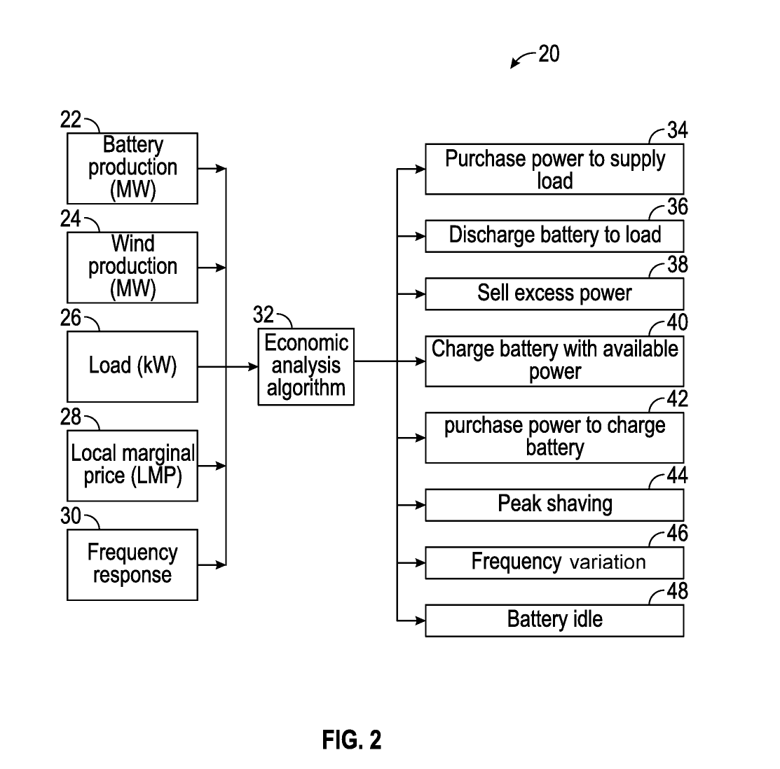

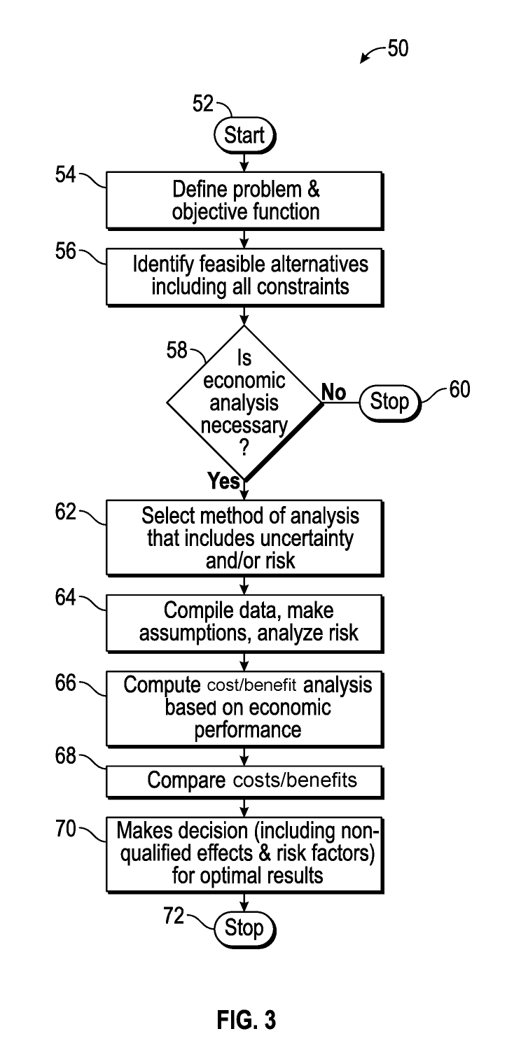

FIG. 2 illustrates a block diagram of a system 20 for economic analysis, in accordance with an example embodiment. The system 20 shown in FIG. 2 provides a solution for the battery action to increase the profit and with less depreciation of the battery life. A method for the analysis is laid out in FIG. 3, in accordance with an example embodiment. The system 20 is composed of an economic analysis module 32 that receives and processes data including battery production data 22, wind production 24, load data 26, local marginal price (LMP) data 28, and frequency responds data 30. As a result of processing such data, the module 32 can implement the instructions contained in modules 34, 36, 38, 40, 42, 44, 46 and 48. For example, module 34 can provide instructions to purchase power to the supply load. Module 36 includes instructions to discharge the batter to the load. Module 38 includes instructions to sell excess power. Module 40 includes instructions to charge the battery with available power. Module 42 can implement instructions to purchase power to charge the battery. Module 44 includes peak shaving instructions. Module 46 includes instructions for frequency variation. Module 48 can include instructions that render the battery idle.

The module 20 depicted in FIG. 2 can implement an algorithm based on the various input data such as, for example, battery production (MW) wind production (MW), load (KW), local marginal price (LMP), and the frequency response of the system. The inputs 22, 24, 26, 28, and 30 can be fed into the module 20 as shown in FIG. 2. The battery performance or its recommended action is obtained as outputs. Some of the battery outputs considered are as follows: when is the optimal time to purchase the power to supply to load; discharge battery power to load, charge the battery with available power, sell excess power, purchase power to charge battery, peak shaving, frequency variation, and conditions when the battery could idle.

FIG. 3 illustrates a flow chart of operations depicting method 50 of economic analysis, in accordance with an example embodiment. As indicated at block 52, the process can begin. Then, as shown at block 54, a step or operation can be implemented to define a problem and an objective function. Next, as depicted at block 56, a step or operation can be implemented to identify feasible alternatives including all constraints. Thereafter, as illustrate at block 58, a step or operation can be implemented to determine if an economic analysis is necessary. If it is determined that such an economic analysis is not necessary then the process stops, as depicted at block 60. If it is determined that such an economic analysis is necessary, then the process continues.

As indicated at block 62, a step or operation can be implemented to select a method of economic analysis that includes uncertainty and/or risk. Thereafter, as illustrated at block 64, a step or operation can be implemented to compile data, make assumptions, and analyze risk. Then, as described at block 66, a step or operation can be implemented to compute a cost/benefit analysis based on factors indicative of economic performance. Next, as illustrated at block 68, a step or operation can be implemented to compare costs/benefits. Then, as shown at block 70, a step or operation can be implemented to make a decision (including non-qualified effects and risk factors) for optimal results. The process can then terminate, as depicted at block 72.

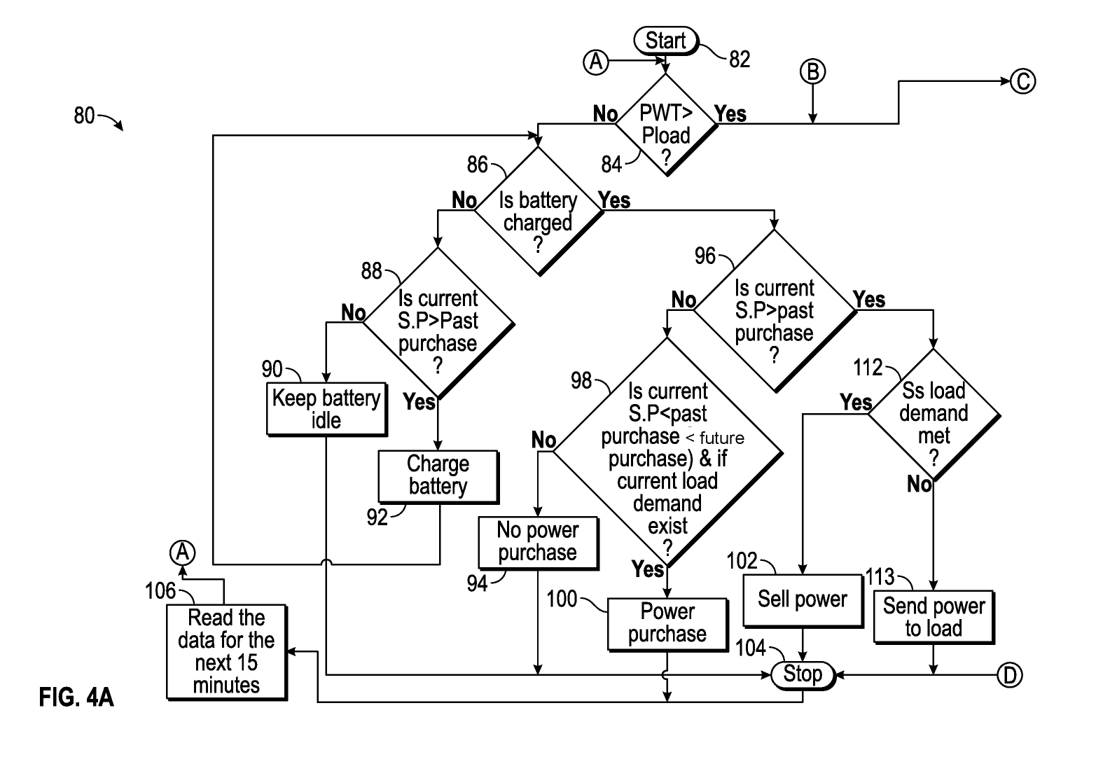

FIGS. 4A-4B illustrate a flow chart of operations depicting a method for determining conditions when wind power is greater than the load and when it is less than the load, in accordance with an example embodiment. That is, the operations shown in the generalized flowchart in FIGS. 4A-4B consider the condition when the wind power is greater than the load and when it is less than the load. As indicated at block 82, the process begins. Then, as shown at decision block 84, a test can be performed to determine if PWT is greater than Pload. If the answer is “no,” then the process beginning with the operation shown in decision block 86 can be implemented. That is, as indicated at decision block 88, a test is performed to determine if the battery is charged. If not, then as described at decision block 88, a test can be performed to determine if the current S.P. is greater than a past purchase. If not, then as indicated at block 90, the battery is kept idle. If so, then as shown at block 92, the battery is charged. Following processing of the operation shown at block 92, the process loops back to the point prior to decision block 86.

Assuming that a “yes” answer is determined in response to the operation shown at block 86, an operation can be implemented as indicated at decision block 96 to determine if the current S.P. is greater than a past purchase. If not, then as indicated at decision block 98, a test can be performed to determine if the current S.P.<past purchase<future purchase and if a current load demand exists. If not, then power is not purchased as indicated at block 94. If so, then power is purchased as shown at block 100. Following processing of either the operations depicted at blocks 94 or 100, the process stops as shown at block 104 followed by implementation of an operation involving reading the data for the next 15 minutes as shown at block 106.

Assuming the answer with respect to the operation depicted at decision block 96 is “yes”, an operation can be implemented, as shown at decision block 112 to determine if the load demand has been met. If the answer is “yes,” then an operation can be implemented to “sell power” as shown at block 102, followed by the stop operation depicted at block 104 and so on. If the load demand has not been met, then as depicted at block 113, an, operation can be implemented to send the power to load followed by the stop operation shown at block 104 and so on.

Returning now to the operation depicted at block decision block 84, if the answer is “yes,” then as indicated at decision block 108, a step or operation can be implemented to determine if the battery is charged. If it is determined that the battery has been charged, then as illustrated at block 109, a step or operation can be implemented to sell excess energy follows. The process can then end, as shown at block 110. If it is determined that the battery has not been charged (i.e., as shown at decision block 108), then a test can be performed, as indicated at block 114 to determine if the excess power is sufficient to fully charge the battery. If the answer is “yes,” then a step or operation can be implemented to charge the battery fully, as depicted at block 122.

Thereafter, as shown at block 124, the excess power can be sold following by the “stop” operation depicted at block 104 and so on. If it is determined, however, that there is not sufficient excess power to fully charge the battery (i.e., see decision block 114), then as shown at decision block 116, a test can be implemented to determine if “excess power>P (tc)”. If the answer is “no,” then a test is performed as described at decision block 118 to determine if “SP>past purchase at high cost”. If the answer is “yes,” then as described at block 120, a test or operation can be implemented to sell the excess power. If the answer is “no,” then the battery can be charged, as shown at block 119.

Assuming that the answer with respect to test shown at decision block 116 is “yes,” then another test can be performed as depicted at decision block 126 to determine if “(excess S.P.—purchase price of remaining energy)>future peak load”. If the answer is “yes,” then a step or operation can be implemented to sell excess power as shown at block 128. If the answer with respect to decision block 126 is “no,” then a step or operation can be implemented to charge the battery as shown at block 119.

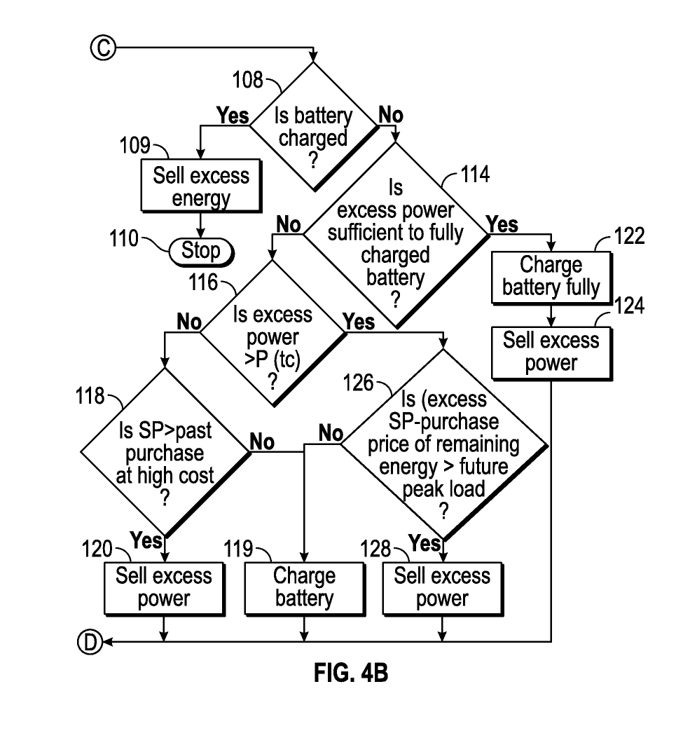

FIGS. 5A-5B illustrate a flow charge of operations depicting a method 81 for considering possible cases when the power supply from the renewable source is less and unable to meet the load, in accordance with an example embodiment. The method 81 depicted in FIGS. 5A-5B considers the possible cases when the power supply from the renewable source is less and unable to meet the load. For both the conditions, the battery state of charge is considered based on which decisions are made by comparing the past, present, and future cost data.

The process can begin as shown at block 140. Thereafter, as indicated at decision block 141, a test can be implemented to determine if PWT>Pload. If the answer is “no,” then a test can be performed as depicted at decision block 142 to determine if the battery is in a charged state. If the answer is “yes,” then a determination is made that peak load shaving is not possible as shown at block 144 followed by a test to determine if the current present price is less than the future price, as shown at decision block 146. If the answer with respect to decision block 146 is “no,” then as depicted at decision block 148, a test can be implemented to determine if the load demand has been met. If the load demand has not been met, then as shown at block 149, an operation can be implemented to purchase power and then as shown at block 151, the power can be sent to the load. If the load demand has been met, then the battery can be kept idle, as shown at block 150. Thereafter, the process can stop as shown at block 161 and an operation can be implemented to read the data for the next 15 minutes. Assuming the answer is “yes” with respect to the test described at decision block 146, the battery can be charged, as shown at block 147.

If the answer with respect to the test described at decision block 142 is “yes,” then a test as shown at decision block 152 can be implemented, wherein is Power (all sources)>than Pload? If the answer with respect to decision block 152 is “yes,” then the battery is automatically discharged to shave the peak load, as shown at block 162. If the answer with respect to the test shown at decision block 152 is “no,” then a test can be performed to determine if a frequency dip has occurred, as indicated at decision block 154. If it is determined that a frequency dip did not occur, then the operation shown at decision block 156 is processed. If it did occur, then the operation shown at block 162 is processed. The test shown at decision block 156 determines if PP>past battery charge cost. Thereafter, as depicted at block 158, a test can be implemented to determine if PP>future cost. Thereafter, if “no,” then a step or operation can be performed as shown at block 166 to discharge the battery in the future when F.P.>>PP. If the answer is “yes” with respect to the test depicted at block 158, then the battery can be discharged as described at block 160 and so on.

Other operations can be implemented following the test performed as shown at decision block 141. For example, as shown at block 170, partially charged (static) operation can be implemented followed by a Psource load test as shown at block 172 and then another frequency dip test as shown at block 174 (i.e., similar to the frequency dip test depicted at block 154). Other operations, which can be implemented, include a test for determining the battery charging state as shown at block 176 followed by another frequency dip test as depicted at block 178 and thereafter an operation to stop charging the battery and start discharging the battery as indicated at block 180. Continue operations are indicated at blocks 182 and 184 with respect to the tests respectively described at decision blocks 176 and 178.

Note that in an example embodiment, some assumptions can be made, as follows:

1) Battery Capacity is 1 MWh

2) Wind capacity is 1.7 MW

3) Maximum Load is considered to be between 2 W to 3 MW

4) Charge the battery with constant Charge Rate(i.e. Constant C rate)

5) If a battery is charged it is charged to a maximum of 90% S.O.C

6) If a battery is discharged it is discharged to a minimum of 20% S.O.C

7) Program reads the data for every 15 minutes from the excel files.

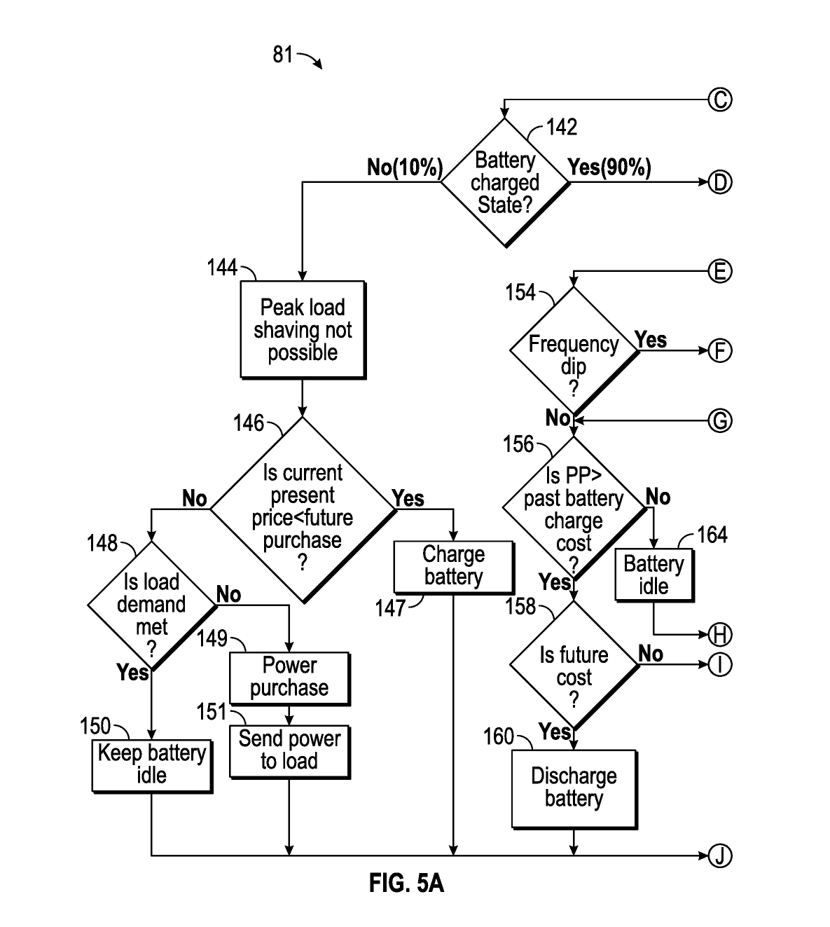

Some of the conditions and cases from the FIGS. 4A-4B and FIGS. 5A-5B are explained as follows with respect to FIGS. 6, 7 and 8 (i.e., Case 1, Case 2, and Case 3).

FIG. 6 illustrates a screen shot 190 of graphically displayed fields (i.e., a GUI (Graphical User Interface)) with output data regarding the selling of excess power and a recommended course of action to charge a battery in the future, in accordance with an example embodiment. That is, FIG. 6 illustrates Case 1, wherein if power from the wind turbine is greater than the load demand and battery is in discharged state, then condition “If excess power is sufficient to charge the battery” is checked. Also, “If Excess energy can be sold at higher prices in future than the present purchase price of energy at peak load or at high price”, the recommended action is to “Sell Excess Power and charge battery in future” as in FIG. 6.

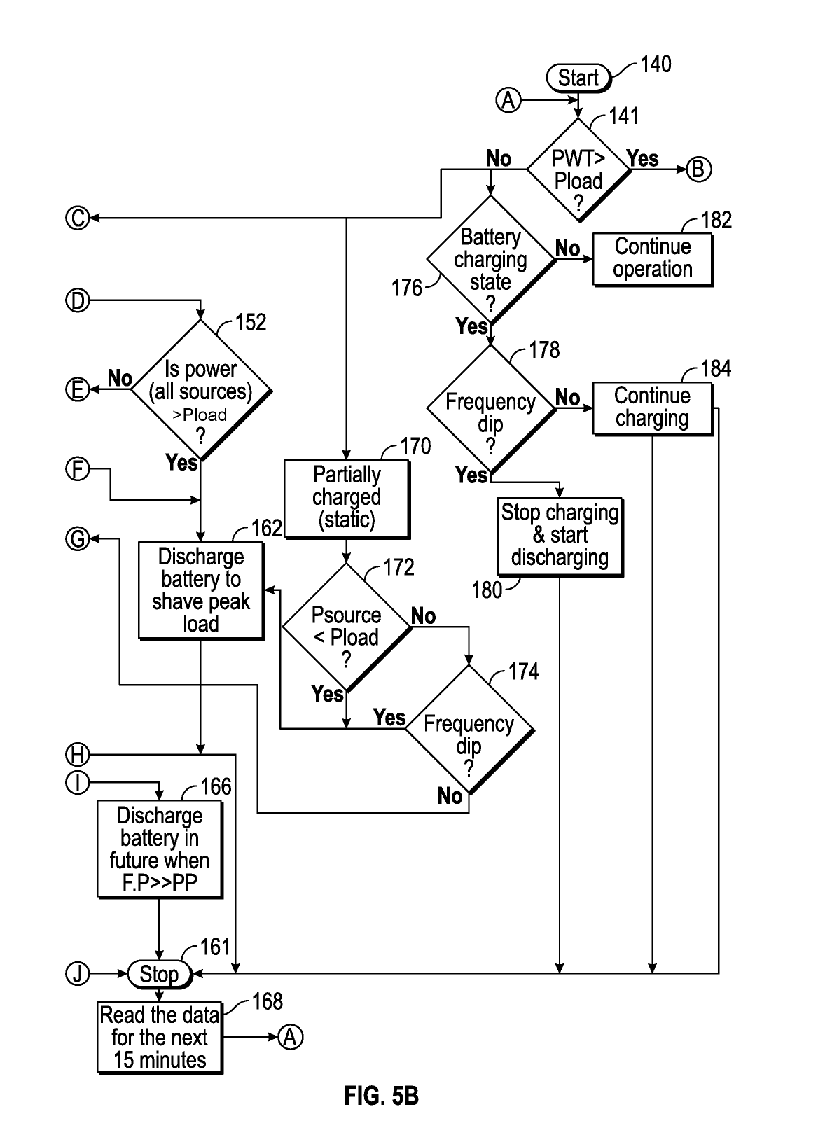

FIG. 7 illustrates a screen shot 192 of graphically displayed fields (i.e., a GUI) with output data indicating a recommended course of action to charge a battery, in accordance with an example embodiment. FIG. 7 illustrates Case 2, wherein if power from wind turbine is greater than the load demand and battery is in discharged state, then condition “If excess power is sufficient to charge the battery” is checked. Also, “If Excess energy cannot be sold at higher prices in future than the present purchase price of energy at peak load or at high price”, the recommended action is to “Charge battery with excess power” as in FIG. 7.

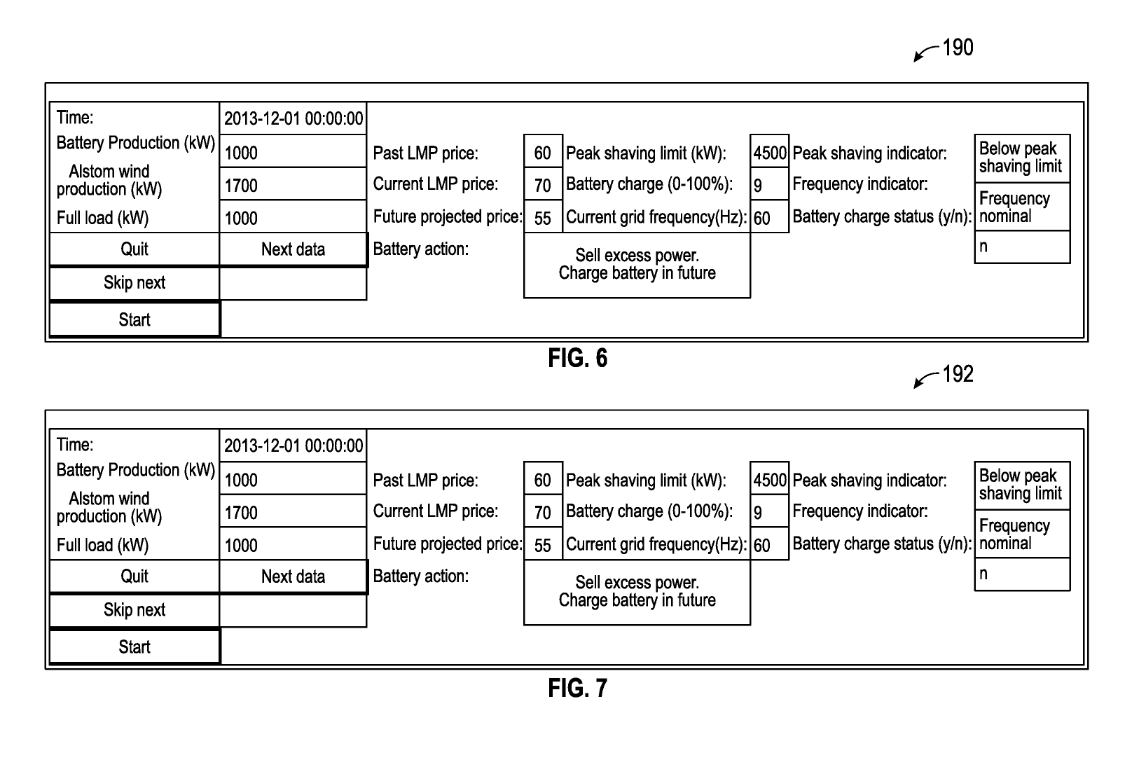

FIG. 8 illustrates a screen shot 196 of graphically displayed fields (i.e., a GUI) with output data indicating a recommended course of selling excess energy and discharging the battery in the present, in accordance with an example embodiment. FIG. 8 illustrates Case 3, wherein if power generated from wind turbine is greater than the load demand and battery is in charged state, then condition “If present selling price is greater than past energy to charge the battery” is checked and “if yes, then again it is checked if the present price is greater than the future selling price,” then the recommended action is to “Sell the excess energy and discharge battery at present” as in FIG. 8.

As can be appreciated by one skilled in the art, at least some example embodiments may be implemented in the context of a method, data processing system, or computer program product. Accordingly, such embodiments may take the form of an entire hardware embodiment, an entirel software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

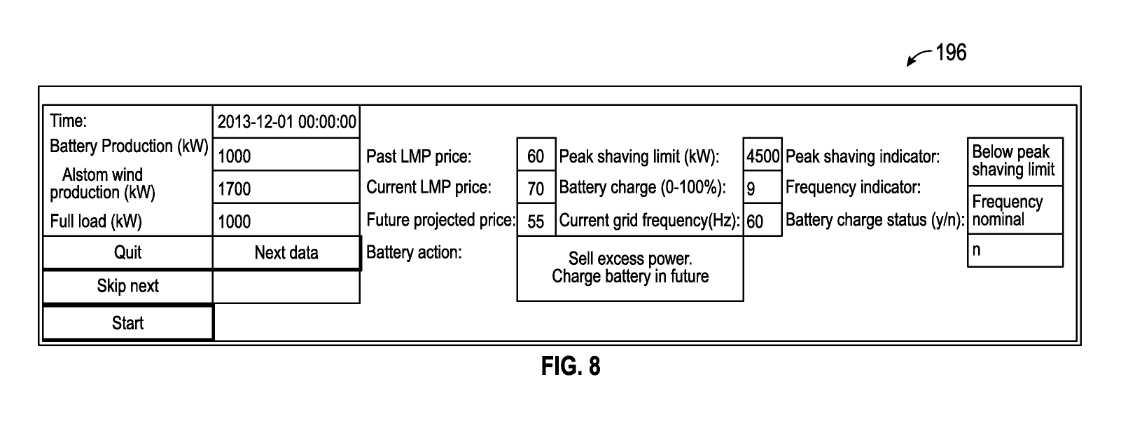

FIGS. 9-10 are provided as exemplary diagrams of data-processing environments in which embodiments of the present invention may be implemented. It should be appreciated that FIGS. 9-10 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 9, some embodiments may be implemented in the context of a data-processing system 200 that includes, for example, a processor 241 such as a CPU, a memory 242, an input/output controller 243, an image capturing unit or camera(s) 232, a keyboard 244, an input device 245 (e.g., a pointing device, such as a mouse, track ball, and pen device, etc.), a display 246, and a USB (Universal Serial Bus) peripheral connection 247. As illustrated, the various components of data-processing system 200 can communicate electronically through a system bus 261 or similar architecture.

The system bus 261 may be, for example, a subsystem that transfers data between, for example, computer components within data-processing system 200 or to and from other data-processing devices, components, computers. etc. It can be appreciated that some of the components shown in FIG. 9 are optional and desirable only in certain situations. For example, the image-capturing unit 232 may or may not be included with data-processing system 200 in some embodiments, but may be desirable in the case of, for example, Smartphone or laptop computer implementations, which often include a video camera. In some embodiments, system 200 may function as server in the context of a client/server network architecture or other computer network architecture (e.g., the Internet)

FIG. 10 illustrates a computer software system 250 for directing the operation of the data-processing system 200 depicted in FIG. 9. Software application 254, stored for example in memory 142, generally includes a kernel or operating system 251 and a shell or interface 253. One or more application programs, such as software application 254, may be “loaded” (i.e.. transferred from, for example, a mass storage or other memory location into the memory 142) for execution by the data-processing system 200. The data-processing system 200 can receive user commands and data through an interface 253; these inputs may then be acted upon by the data-processing system 200 in accordance with instructions from operating system 251 and/or software application 254. The interface 253 in some embodiments can serve to display results, whereupon a user 249 may supply additional inputs or terminate a session. The software application 254 can include a module 252 that can implement instructions or logical operations such as those described herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances a “module” constitutes a software application.

Generally, program modules include, but are not limited to, routines, subroutines. software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The module 252 shown in FIG. 10 can thus implement instructions such as those shown and described and illustrated herein with respect to, for example, the operations and/or blocks shown in FIGS. 3, 4A-4B, and 5A-5B and described elsewhere such as with respect to the graphically displayed fields and data shown in FIGS. 6, 7, and 8. It can be appreciated, however, that such blocks/operations and instructions thereof are not limiting features of the disclosed embodiments. Other operations can be implemented with or in lieu of such instructions/operations.

FIGS. 9-10 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions/instructions/steps described herein represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc,) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, Visual Basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modem microprocessor will often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g.. 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it recognizes a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts, the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations. it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims.

What is claimed is:

1. A method for physically optimizing energy usage and derive an economic benefit from a high energy storage system, said method comprising:
optimizing energy flow between a renewable energy facility and a utility utilizing an installed battery system that includes at least one battery in the context of a high-energy storage system; and
performing an economic analysis of said high energy storage system that includes considering and processing a plurality of factors as a part of said economic analysis including how to determine an optimal time to charge and discharge said at least one battery in said installed battery system and whether to sell excess power and/or implement peak shaving so as to maximize an economic benefit from said renewable energy facility, said utility, and said installed battery system.

2. The method of claim 1 further comprising determining a battery life cycle estimation.

3. The method of claim 1 wherein said plurality of factors includes:
a cost of energy required to purchase the power to charge said at least one battery;
a cost of energy required to sell the excess power with respect to said at least one battery; and
an availability of renewable power in an economic manner considering the past, present, and future cost analysis with respect to said at least one battery.

4. The method of claim 1 further comprising graphically displaying at least one factor among said plurality of factors in a graphical user interface including recommended actions with respect to said at least one battery.

5. The method of claim 1 wherein said renewable energy facility comprises a wind farm.

6. The method of claim 1 wherein said plurality of factors includes battery production data with respect to said at least one battery, wind production data with respect to said wind farm, load data, local marginal price (LMP) data, and frequency response data.

7. The method of claim 1 further comprising determining an economic feasibility with different business opportunities in response to performing said economic analysis on said high energy storage system.

8. The method of claim 1 wherein said at least one battery is associated with at least one wind production module and is operably coupled to at least one AC-DC-AC converter which in turn is operably coupled to at least one electrical transformer that provides energy to a main grid.

9. The method of claim 1 wherein said at least one battery is operably coupled to at least one DC-AC bi-directional converter which in turn is operably coupled to at least one electrical transformer that provides energy to a main grid.

10. A system for physically optimizing energy usage and derive an economic benefit from a high energy storage system, said system comprising:
a renewable energy facility and a high-energy storage system, wherein energy flow between said renewable energy facility and a utility is optimized utilizing an installed battery system that includes at least one battery in the context of said high-energy storage system: and
a module performing an economic analysis of said high energy storage system that includes considering and processing a plurality of factors as a part of said economic analysis including how to determine an optimal time to charge and discharge said at least one battery in said installed battery system and whether to sell excess power and/or implement peak shaving so as to maximize an economic benefit from said renewable energy facility, said utility, and said installed battery system.

11. The system of claim 10 further comprising a module for determining a battery life cycle estimation.

12. The system of claim 10 wherein said plurality of factors includes:
a cost of energy required to purchase the power to charge said a least one battery;
a cost of energy required to sell the excess power with respect to said at least one battery; and
an availability of renewable power in an economic manner considering the past, present, and future cost analysis with respect to said at least one battery.

13. The system of claim 10 further comprising a graphical user interface that graphically displays at least one factor among said plurality of factors within said graphical user interface including recommended actions with respect to said at least one battery.

14. The system of claim 10 wherein said renewable energy acuity comprises, a wind farm.

15. The system of claim 14 wherein said plurality of factors includes battery production data with respect to said at least one battery, wind production data with respect to said wind farm, load data, local marginal price (LMP) data, and frequency response, data.

16. The system of claim 10 further comprising a module for determining an economic feasibility with different business opportunities in response to performing said economic analysis on said high energy storage system.

17. The system of claim 10 wherein said at least one battery is associated with at least one wind production module and is operably coupled to at least one AC-DC-AC converter which in turn is operably coupled to at least one electrical transformer that provides energy to a main grid.

18. The system of claim 10 wherein said at least one battery is operably coupled to at least one DC-AC bi-directional converter which in turn is operably coupled to at least one electrical transformer that provides energy to a main grid.

19. A system for physically optimizing energy usage and derive an economic benefit from a high energy storage system, said system comprising:
a renewable energy facility and a high-energy storage system that includes an installed battery system, wherein energy flow between said renewable energy facility and a utility is optimized utilizing said installed battery system that includes at least one battery in the context of said high-energy storage system;
at least one processor; and
a computer-usable medium embodying computer program code, said computer-usable medium capable of communicating with said at least one processor, said computer program code comprising instructions executable by said at least one processor and configured for performing an economic analysis of said high energy storage system that includes considering and processing a plurality of factors as a part of said economic analysis including how to determine an optimal time to charge and discharge said at least one battery in said installed battery system and whether to sell excess power and/or implement peak shaving so as to maximize an economic benefit from said renewable energy facility, said utility, and said installed battery system.

20. The system of claim 19 further comprising a graphical user interface that graphically displays at least one factor among said plurality of factors within said graphical user interface including recommended actions with respect to said at least one battery.
